(19) United States
(12) Patent Application Publication
(10) Pub. No.: US 2025/0021510 A1
(43) Pub. Date: Jan. 16, 2025

(54) INFORMATION PROCESSING DEVICE, AND METHOD FOR CONTROLLING INFORMATION PROCESSING DEVICE

(71) Applicant: NEC Corporation, Minato-ku, Tokyo (JP)

(72) Inventor: Kiyoshi Baba, Tokyo (JP)

(73) Assignee: NEC Corporation, Minato-ku, Tokyo (JP)

(21) Appl. No.: 18/712,775

(22) PCT Filed: Nov. 28, 2022
(86) PCT No.: PCT/JP2022/043678

§ 371 Date: May 23, 2024

(30) Foreign Application Priority Data
Dec. 16, 2021 (JP) 2021-204359

(51) Int. Cl. G06F 13/42

(52) U.S. Cl. CPC G06F 13/4221; G06F 2213/0026

(57) ABSTRACT

The present invention provides an information processing device and a method for controlling an information processing device that can increase the number of devices that can be recognized without special software. The information processing device includes a central processing unit and a host bus adapter in which input/output (I/O) devices conforming to the PCI Express standard are connected to a fabric, wherein the host bus adapter is an input/output interface of the PCI Express standard and uses a fabric communication function to communicate with an input/output unit (IOU) including at least one of the I/O devices, and the host bus adapter includes a functional part including a plurality of functions conforming to the PCI Express standard, and a mapping table in which the functions of the functional part and external I/O devices connected to the fabric are mapped in association with each other.

### TECHNICAL FIELD

The present invention relates to an information processing device and a method for controlling the information processing device, and particularly relates to an information processing device to which external devices represented by network devices and storage devices are connected, and a method for controlling the information processing device.

### BACKGROUND ART

In an information processing device, for example, a host bus adapter (HBA) is provided as an input/output (I/O) interface to which external devices represented by network devices and storage devices are connected. An example of such an I/O interface is peripheral component interconnect Express (PCI Express) (registered trademark). Note that, in this specification, PCI Express may hereinafter be abbreviated as PCIe. PCIe is a type of expansion bus developed by PCI special interest group (PCI-SIG), and is used by a computer. PCIe employs a serial transfer interface and a full-duplex communication scheme.

In PCIe, an external device connected thereto is identified by three numbers called BDF (Bus, Device, Function). In PCIe, a bus number is defined by 8 bits.

PTL 1 relates to expansion of a PCIe fabric. PTL 1 proposes that a PCIe device includes a host PCIe fabric including a host root complex, the host PCIe fabric having a first set of bus numbers and a first memory mapped input/output (MMIO) space on a host CPU. PTL 1 also proposes that the PCIe fabric includes a root complex endpoint (RCEP) as a part of an endpoint of the host PCIe fabric. Further, PTL 1 proposes that the PCIe fabric has a second set of bus numbers and a second MMIO space separate from the first set of bus numbers and the first MMIO space, respectively.

PTL 2 relates to a computer system in which a plurality of computers and a plurality of I/O devices are connected to each other via PCIe switches. PTL 2 proposes that in a case where the PCIe switches are connected to an I/O controller in multiple stages and an I/O device is connected to a PCIe switch at the last stage, connection association between PCI-PCI bridges is changed. PTL 2 proposes that bus numbers are flexibly allocated to I/O devices by changing the connection association between PCI-PCI bridges to prevent a decrease in the number of connectable I/O devices.

PTL 3 relates to a communication system that controls an Express Ether network. PTL 3 describes that Express Ether is a technology for achieving “PCI Express over Ether”. The “PCI Express over Ether” is an extension of a PCI Express bus onto Ethernet (registered trademark). In addition, PTL 3 describes that a transaction layer packet (TLP) defined according to the PCI express specification is transmitted and received in an encapsulated state via a network in Express Ether.

### CITATION LIST

### Patent Literature

PTL 1: JP 2018-125028 A
PTL 2: WO 2012/073304 A1
PTL 3: JP 2016-144142 A

### SUMMARY OF INVENTION

### Technical Problem

However, in the information processing device using PCIe as an I/O interface, since a bus number is defined by 8 bits according to the PCIe specification, there is a problem that only up to 256 devices can be recognized and mounted in one information processing device.

A technology called single root-I/O virtualization (SR-IOV) for virtually implementing a plurality of functions in one device is defined by PCIe. In this technology, it is possible to cause the system to recognize a plurality of devices with one bus number. However, a plurality of devices that are not compatible with SR-IOV cannot be shown. For this reason, there is a need for a technology capable of enabling one information processing device to recognize 257 or more devices even if any of the devices is not compatible with SR-IOV.

Neither PTL 2 nor PTL 3 proposes an implementation means capable of recognizing such a number of devices exceeding the PCIe specification. PTL 2 merely proposes preventing a bus number from being consumed in the PCIe switch, and does not propose an implementation means enabling one information processing device to recognize 257 or more devices.

In PTL 1, a PCIe configuration space for a first level PCIe fabric can be used only up to 256 MB. Therefore, special software is required to assign an extended PCIe fabric to a space different from the first level PCIe fabric and access the extended PCIe fabric.

In view of the above-described problems, an object of the present invention is to provide an information processing device capable of increasing the number of devices that can be recognized without preparing special software, and a method for controlling the information processing device.

### Solution to Problem

In order to achieve the foregoing object, an information processing device according to the present invention is an information processing device including a central processing unit and a host bus adapter in which input/output (I/O) devices conforming to a PCI Express standard are connected to a fabric,
in which the host bus adapter is an input/output interface of the PCI Express standard, and communicates with an input/output unit (IOU) including at least one of the I/O devices by a fabric communication function, and
the host bus adapter includes a functional unit including a plurality of functions conforming to the PCI Express standard, and a mapping table in which the functions of the functional unit and external I/O devices connected to the fabric are mapped in association with each other.

A method for controlling an information processing device according to the present invention is a method for controlling an information processing device including a central processing unit and a host bus adapter in which input/output (I/O) devices conforming to a PCI Express standard is connected to a fabric,
in which the host bus adapter is an input/output interface of the PCI Express standard, and
the host bus adapter communicates with an input/output unit (IOU) including at least one of the I/O devices by a fabric communication function with reference to a mapping table in which a plurality of functions conforming to the PCI Express standard are associated with external I/O devices connected to the fabric.

### Advantageous Effects of Invention

According to the present invention, it is possible to provide an information processing device capable of increasing the number of devices that can be recognized without preparing special software, and a method for controlling the information processing device.

### BRIEF DESCRIPTION OF DRAWINGS

FIG. 1 is a block diagram for explaining an example of an information processing device according to an example embodiment of a superordinate concept of the present invention.

FIG. 2 is a block diagram for explaining an information processing device according to an example embodiment of the present invention.

FIG. 3 is a block diagram for explaining a detailed configuration of a main part of FIG. 2.

FIG. 4 is a conceptual diagram illustrating an example of a mapping table 22 of FIG. 3.

FIG. 5 is a conceptual diagram illustrating an example of a routing table.

FIG. 6A is a sequence chart for explaining an operation of the information processing device according to the example embodiment.

FIG. 6B is a sequence chart for explaining an operation of the information processing device according to the example embodiment.

FIG. 6C is a sequence chart for explaining an operation of the information processing device according to the example embodiment.

### EXAMPLE EMBODIMENT

### Outline of Example Embodiment

An information processing device according to an example embodiment of the present invention is, for example, an information processing system based on a technology capable of extending PCI Express (PCIe) to a fabric, such as Express Ether. Then, in a host bus adapter (HBA) mounted on the information processing device side, PCIe is terminated as an end point that supports multiple functions. Then, I/O devices connected to the end of the fabric are mapped to the multiple functions in the HBA. This enables the information processing system to recognize 257 or more I/O devices (PCIe standard).

### [Example Embodiment of Superordinate Concept]

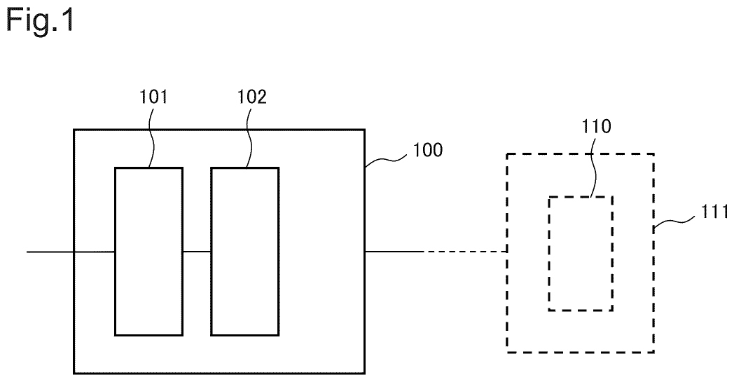

Prior to describing a specific example embodiment of the present invention, an information processing device and a method for controlling the information processing device according to an example embodiment of a superordinate concept of the present invention will be described. FIG. 1 is a block diagram for explaining an example of an information processing device according to an example embodiment of a superordinate concept of the present invention.

The information processing device of FIG. 1 includes a central processing unit, which is not illustrated, and a host bus adapter 100 in which input/output (I/O) devices 111 conforming to a PCI Express standard are connected to a fabric. The host bus adapter 100 of the information processing device of FIG. 1 is an input/output interface of the PCI Express standard, and communicates with an input/output unit (IOU) 110 including at least one of the I/O devices 111 by a fabric communication function.

The host bus adapter 100 includes a functional unit 101 and a mapping table 102 in which the external I/O devices 111 are mapped in an associating manner. Here, the functional unit 101 includes a plurality of functions conforming to the PCI Express standard. The external I/O devices 111 are connected to the functions of the functional unit 101 and the fabric. The mapping table 102 of the host bus adapter 100 manages mapping between the functions of the functional unit 101 and the I/O devices 111 connected to the functions by the fabric communication function.

The information processing device of FIG. 1 refers to the mapping table 102 for mapping the functions of the functional unit 101 and the external I/O devices 111 connected to the fabric in association with each other. The I/O devices connected to the end of the fabric are mapped to the multiple functions in the HBA. This makes it possible to increase the number of devices that can be recognized without preparing special software. Accordingly, 257 or more I/O devices (PCIe standard) can be recognized. Hereinafter, a more specific example embodiment will be described in detail with reference to the drawings.

### One Example Embodiment

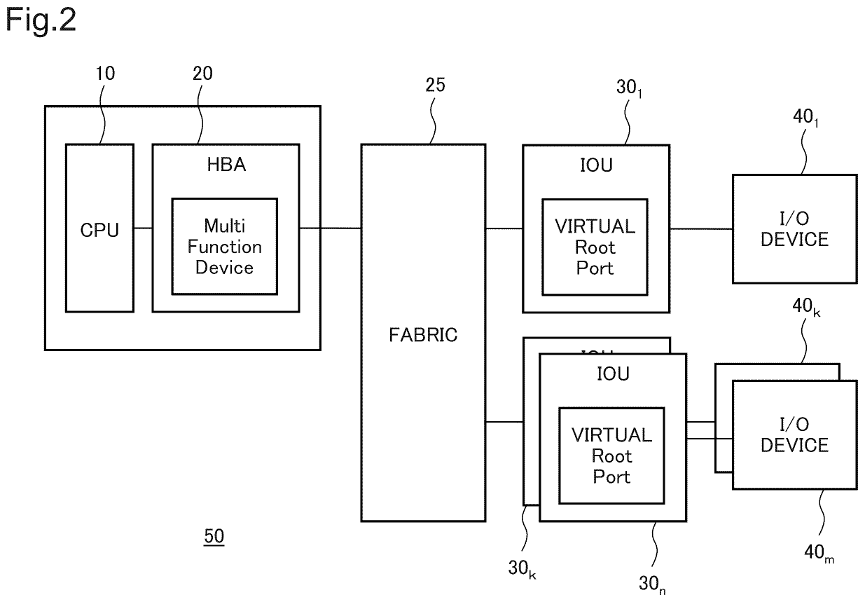

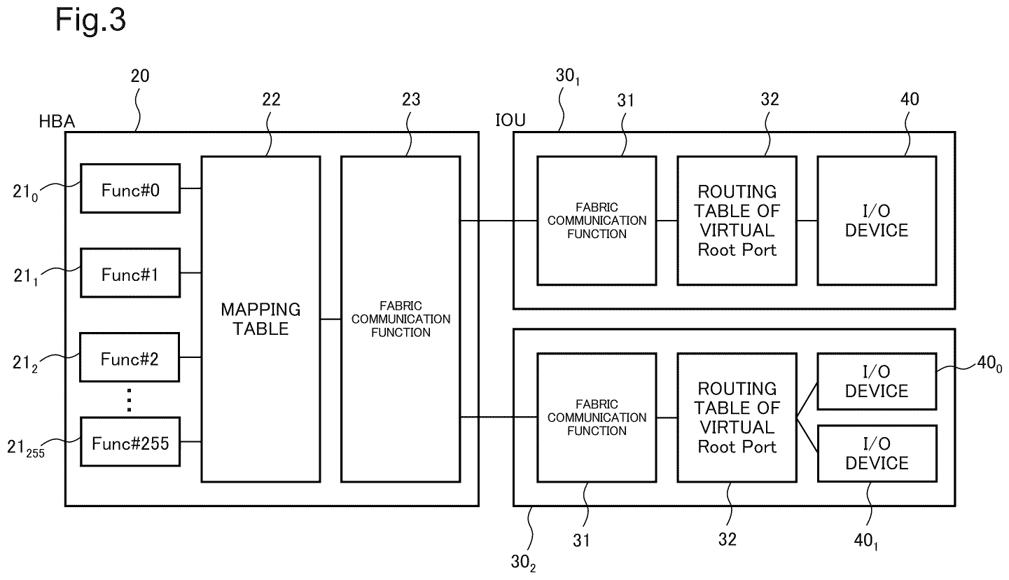

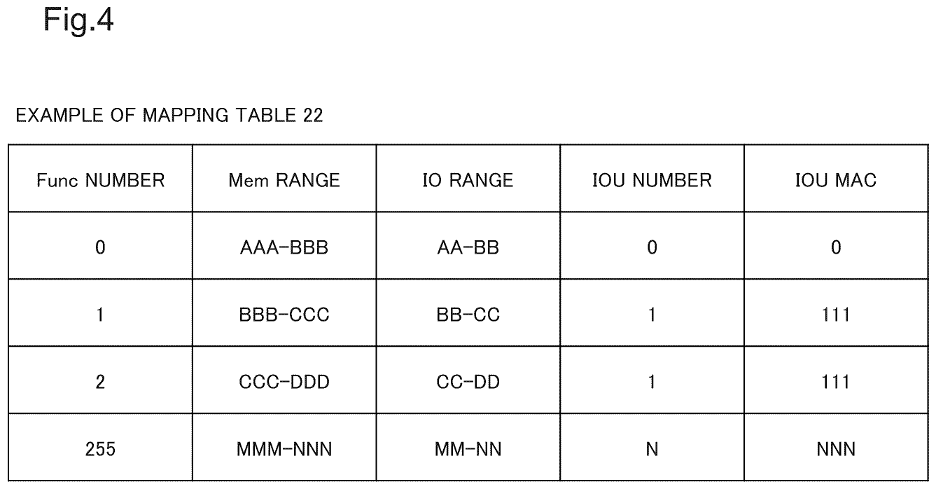

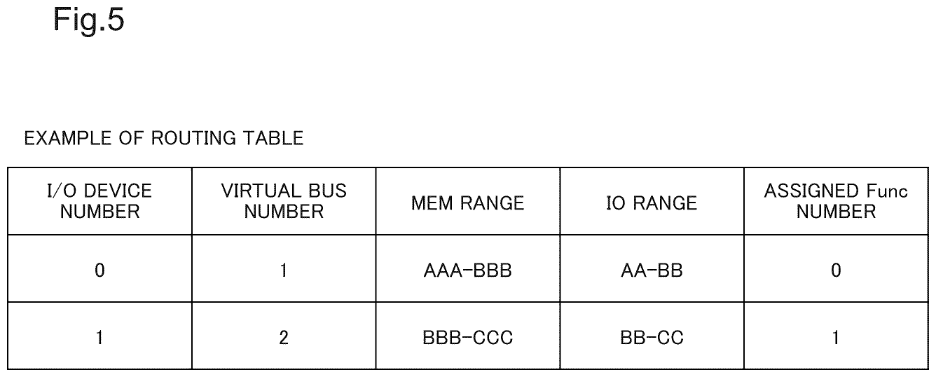

Next, an information processing device and a method for controlling the information processing device according to an example embodiment of the present invention will be described. FIG. 2 is a block diagram for explaining an information processing device according to an example embodiment of the present invention. FIG. 3 is a block diagram for explaining a detailed configuration of a main part of FIG. 2. FIG. 4 is a conceptual diagram illustrating an example of a mapping table 22 of FIG. 3. FIG. 5 is a conceptual diagram illustrating an example of a routing table.

### (Configuration of Example Embodiment)

The information processing device of FIG. 2 includes a central processing unit (CPU) 10 and a host bus adapter (HBA) 20. An input/output unit (IOU) 30 is connected to the information processing device of FIG. 2 via a fabric 25. FIG. 2 illustrates a case where a plurality of IOUs are connected, and illustrates a case where an IOU 30₁, an IOU 30ₖ, and an IOU 30ₙ are connected as an example. Here, k and n are, for example, integers satisfying 1<k<n. FIG. 2 illustrates a case where a plurality of I/O devices are also connected, and illustrates a case where an I/O device 40₁ is connected to the IOU 30₁, an I/O device 40ₖ is connected to the IOU 30ₖ, and an I/O device 40ₘ is connected to the IOU 30ₙ as an example. Here, k and m are, for example, integers satisfying 1<k<256<m.

FIG. 3 illustrates a case where the HBA 20 of FIG. 2 and IOUs 30₁ and 30₂ as examples of the plurality of IOUs 30 are included as a detailed configuration of the information processing device of FIG. 2. The HBA 20 of FIG. 3 includes a plurality of function units (Func #0 to Func #255) as examples of the plurality of function units, a mapping table 22, and a fabric communication function unit 23. The plurality of function units (Func #0 to Func #255) may hereinafter be referred to as a plurality of function units 21 or function units 210 to 21255. Note that FIG. 3 illustrates a case where the number of function units 21 from #0 to #255 is 256 in total, but the number of function units is not limited thereto in the example embodiment of the present invention, and may be larger than 256.

The IOU 30 connected to the HBA 20 of FIG. 3 includes a fabric communication function unit 31, a virtual root port 32, and one or more I/O devices 40. In FIG. 3, the IOU 30₁ includes a fabric communication function unit 31, a virtual root port 32, and an I/O device 40. In FIG. 3, the IOU 30₂ includes a fabric communication function unit 31, a virtual root port 32, and a plurality of I/O devices (an I/O device 40₀ and an I/O device 40₁).

The plurality of function units 21 of the HBA 20 are functions conforming to the PCIe standard, and are defined as multi-function devices. I/O devices 40 mapped to parts other than the parts representing the multiple functions, such as configuration registers, are used as they are. Therefore, parts other than the parts representing the multiple functions, such as configuration registers, are not mounted on the function units 21. Although the number of function units 21 from #0 to #255 is 256 in total in FIG. 3, any number of function units 21 may be mounted.

The mapping table 22 manages mapping between the function units 21 and the I/O devices 40. Information managed by the mapping table 22 is illustrated in FIG. 4. The “Func number” in FIG. 4 indicates a number of a function unit 21. The “IOU number” in FIG. 4 indicates a number of an IOU 30, and the number of the IOU 30 is a number of an IOU 30 in which an I/O device 40 mapped to the function unit 21 is mounted. As illustrated in the IOU 30₂ in FIG. 3, a plurality of I/O devices (e.g., an I/O device 40₀ and an I/O device 40₁) may be mounted in one IOU. The “IOU MAC” in FIG. 4 indicates a media access control (MAC) address to be used by the corresponding IOU 30 to communicate in the fabric. As a result, when there is access to the function unit 21, it is possible to determine to which IOU a packet should be transmitted via the fabric communication function.

The fabric communication function units 23 and 31 have a function of managing connection between the HBA 20 and the IOU 30. The fabric communication function of the fabric communication function units 23 and 31 includes a function of sharing information between devices connected to each other. The information to be shared is which HBA and which IOU are logically connected to each other and/or what is the MAC address of the connection destination. Information sharing is performed by periodic packet transmission or a group management function like Express Ether. The MAC address obtained here is used for the mapping table 22. The information in the mapping table 22 is shared between the HBA 20 and the IOU 30 through the fabric communication function.

The virtual root port 32 of each IOU 30 includes a routing table and has a function of setting a virtual bus number to a subordinate I/O device 40 as a root port. The set bus number is managed by the routing table. An example of the routing table is illustrated in FIG. 5.

The I/O device 40 (40, 40₀, or 40₁) in FIG. 3 is a general I/O device conforming to the PCIe standard.

Next, an operation of an information processing system 50 including the information processing device and the IOU will be described. When the information processing system 50 is activated, a PCI bus number and a BAR space are generally allocated to a device constituting the information processing system 50 by PCI enumeration software.

In the information processing system 50 according to the present example embodiment, it is assumed that the HBA 20 and the IOU 30 are connected to each other by the fabric communication function before the PCI enumeration software operates. Also, it is assumed that a Func number, an IOU number, and an IOU MAC are registered in the mapping table 22 before the PCI enumeration software operates, and that an “I/O device number”, a “virtual bus number”, and an “allocated Func number” are registered in the routing table.

Next, a PCI bus number and a BAR space are allocated to a device by the operation of the PCI enumeration software. In the information processing system 50 according to the present example embodiment, only one PCI bus number, HBA 20, is assigned by the system. The BAR space is allocated for each function by the amount required by the function. At this time, the PCI enumeration software acquires a BAR size requested by the function from the configuration register included in the function.

In the information processing system 50 according to the present example embodiment, an access from the PCI enumeration software to the configuration register is routed to the I/O device using the information in the mapping table 22. The BAR size requested by the I/O device is acquired by the routing using the information in the mapping table 22. As a result, in the information processing system 50, the I/O device 40 is recognized as a function. The acquired BAR space is registered in the mapping table and the routing table as “Mem range” and “IO range” as illustrated in FIGS. 4 and 5. Next, the procedures in an actual access will be described in order.

(Access from CPU to I/O Device)

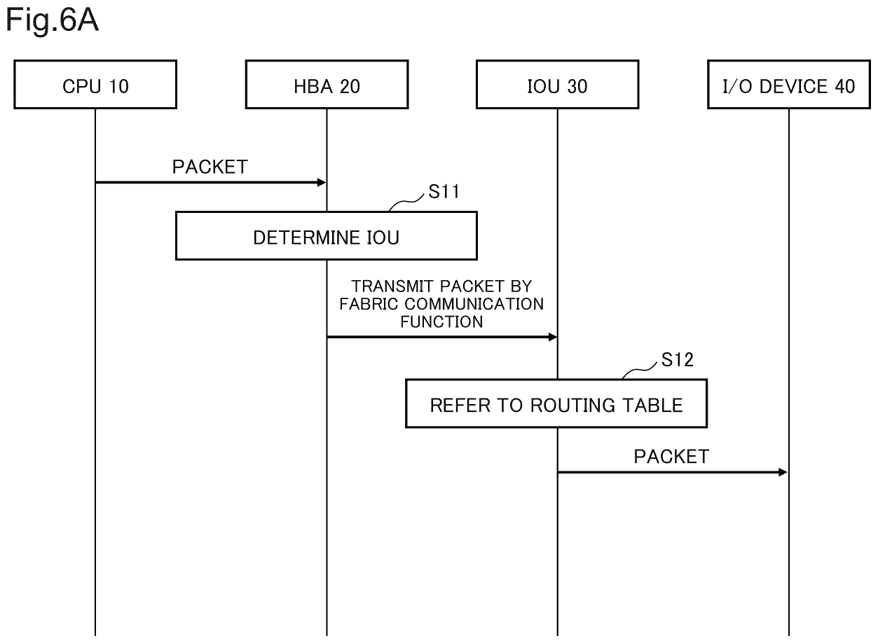

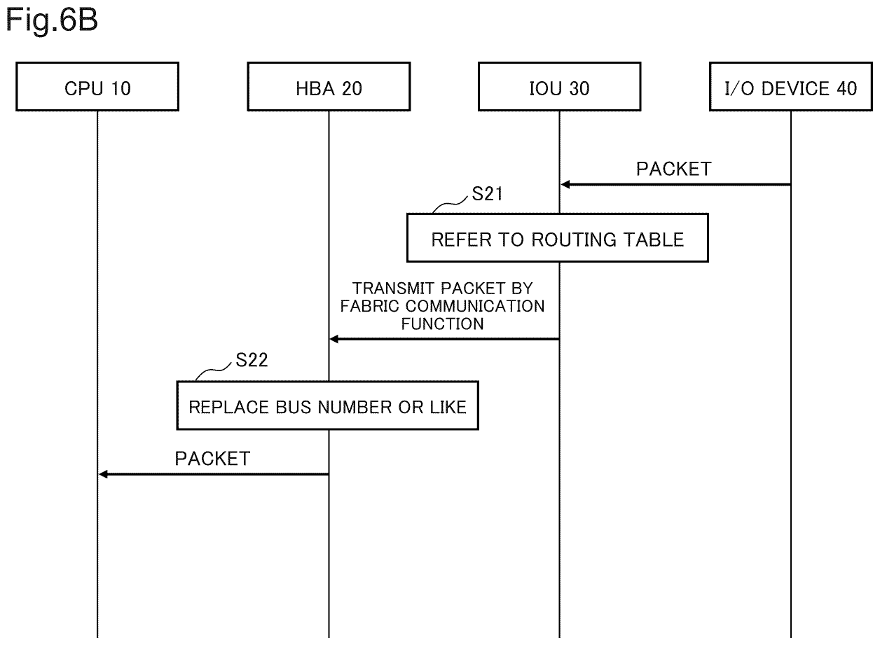

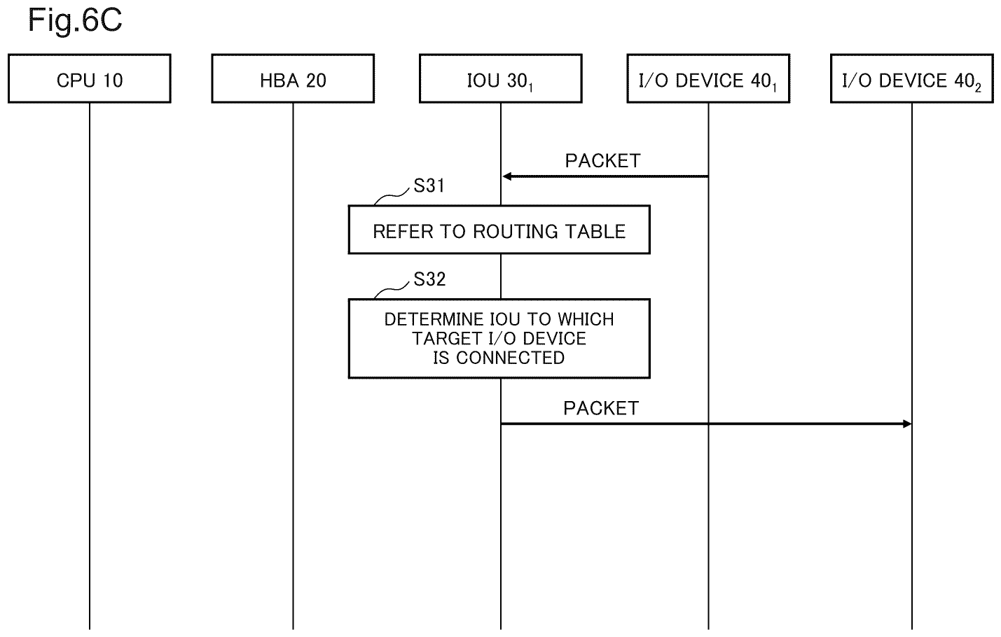

An access from the CPU 10 to the I/O device 40 will be described with reference to a sequence chart of FIG. 6A. For a packet that has arrived at the HBA 20 from the CPU 10, the HBA 20 determines an IOU as a connection destination by referring to the mapping table 22 (S11). Furthermore, the HBA 20 transmits the packet to the IOU determined in S11 by the fabric communication function.

The IOU 30 that has received the packet refers to the routing table of the virtual root port 32 (S12). Furthermore, the IOU 30 transfers the received packet to an I/O device 40 based on a result of referring to the routing table. At this time, in a case where the packet is transmitted using ID routing where a bus number is used, the IOU 30 converts the bus number into a virtual bus number defined in the routing table and transfers the converted bus number (virtual bus number) to the I/O device. Through these procedures, the CPU 10 can access the I/O device 40.

(Access from I/O Device to CPU)

An access from the I/O device 40 to the CPU 10 will be described with reference to a sequence chart of FIG. 6B. The IOU 30 refers to the routing table of the virtual root port 32 for a packet received from the I/O device 40 (S21). When it is determined that the received packet is addressed to the CPU 10 as a result of referring to the routing table, the IOU 30 transmits the packet to the HBA 20 by the fabric communication function.

The HBA 20 that has received the packet via the fabric communication function transfers the packet to a function unit 21 based on the mapping table 22.

The function unit 21 transmits the packet to the CPU 10 after replacing a bus number or the like (BDF [Bus, Device, Function] number) of the packet. Through these procedures, the I/O device 40 can access the CPU 10.

(Access from I/O Device to I/O Device)

An access from an I/O device 40₁ to another I/O device 402 will be described with reference to a sequence chart of FIG. 6C. For a packet received from the I/O device 40₁, the IOU 30 including the I/O device 40₁ refers to the routing table of the virtual root port 32 (S31).

When it is determined that the received packet is addressed to the I/O device 40₂ as a result of referring to the routing table, the IOU 30 determines an IOU 30 to which the target I/O device 40₂ is connected from the mapping table shared by the HBA 20 (S32). Furthermore, the IOUs 30 transmit packets directly between the IOUs 30 via the fabric communication function.

The IOU 30 that has received the packet via the fabric communication function refers to the routing table of the virtual root port 32, and transfers the received packet to the I/O device 40₂ based on a result of referring to the routing table. At this time, in a case where the packet is transmitted using ID routing where a bus number is used, the bus number is converted into a virtual bus number defined in the routing table and the converted bus number is transferred to the I/O device. Through these procedures, the I/O device 40₁ can access another I/O device (the I/O device 40₂).

### Effects of Example Embodiment

The information processing device according to the present example embodiment is capable of connecting I/O devices conforming to the PCI Express standard to one information processing system beyond the number according to the bus number of the PCI Express standard. Specifically, 257 or more I/O devices conforming to the PCI Express standard can be connected to one information processing system. To further explain, 257 or more devices can be connected to one information processing system beyond the upper limit number (256 devices) in the specification of the PCI Express standard in which a bus number is defined by 8 bits. As a result, various systems can be constructed.

In the information processing system 50 illustrated in FIGS. 2 and 3, the HBA 20 has a mapping table 22, and refers to the mapping table 22 at the time of access. In the mapping table 22, the functions (Func #0 to Func #255) of the plurality of function units 21 and the I/O devices 40 connected to the fabric are mapped in association with each other. In other words, in the mapping table 22, the I/O devices 40 connected to the end of the fabric are mapped to the multiple functions in the HBA 20. This makes it possible to increase the number of devices that can be recognized without preparing special software. As a result, the information processing system 50 illustrated in FIGS. 2 and 3 can recognize 257 or more I/O devices (PCIe standard).

### Other Example Embodiments

Although the preferred example embodiment of the present invention has been described above, the present invention is not limited thereto. Although it is illustrated in FIG. 3 as a detailed configuration of the information processing device that 0 to 255 function units 21 (21₀ to 21₂₅₅) are included, the number of the plurality of function units 21 is not limited thereto, and any number of function units 21 may be mounted. In the information processing device of FIG. 2, any number of IOUs 30 (30₁, . . . , 30ₖ, . . . , and 30ₙ) at the end of the fabric 25 and any number of I/O devices 40 (40₁, . . . , 40ₖ, . . . , and 40ₘ) under the IOUs 30 may also be included.

By using the above-described example embodiments of the present invention, a maximum of 256 devices can be connected to one bus number. This allows 60,000 or more devices to be connected to the system, although the system software may not be able to accommodate such a configuration. In that case, it may be considered to limit the number of functions to an upper limit assumed to be handled by the system software. Various modifications may be made within the scope of the invention set forth in the claims, and it goes without saying that the modifications also fall within the scope of the present invention.

Some or all of the above-described example embodiments may be described as in the following supplementary notes, but are not limited to the following supplementary notes.

(Supplementary Note 1) An information processing device including: a central processing unit; and a host bus adapter in which input/output (I/O) devices conforming to a PCI Express standard are connected to a fabric,
in which the host bus adapter is an input/output interface of the PCI Express standard, and communicates with an input/output unit (IOU) including at least one of the I/O devices by a fabric communication function, and
the host bus adapter includes a functional unit including a plurality of functions conforming to the PCI Express standard, and a mapping table in which the functions of the functional unit and external I/O devices connected to the fabric are mapped in association with each other.

(Supplementary Note 2) The information processing device according to supplementary note 1, in which
the IOU including at least one of the I/O devices includes a virtual root port.

(Supplementary Note 3) The information processing device according to supplementary note 2, in which
the virtual root port includes a routing table, and
the virtual root port transfers a packet received via the fabric communication function to a corresponding one of the I/O devices based on the routing table.

(Supplementary Note 4) A method for controlling an information processing device including a central processing unit and a host bus adapter in which input/output (I/O) devices conforming to a PCI Express standard is connected to a fabric,
in which the host bus adapter is an input/output interface of the PCI Express standard, and
the host bus adapter communicates with an input/output unit (IOU) including at least one of the I/O devices by a fabric communication function with reference to a mapping table in which a plurality of functions conforming to the PCI Express standard are associated with external I/O devices connected to the fabric.

This application is based upon and claims the benefit of priority from Japanese patent application No. 2021-204359, filed on Dec. 16, 2021, the disclosure of which is incorporated herein in its entirety by reference.

### REFERENCE SIGNS LIST

10 CPU
20 HBA
21, 21₀ to 21₂₅₅ function unit
22 mapping table
23 fabric communication function unit
25 fabric
30, 30₁ to 30ₖ, 30ₙ IOU
31 fabric communication function unit
32 virtual root port
40, 40₁ to 40ₖ, 40ₙ I/O device
50 information processing system
100 host bus adapter
101 functional unit
102 mapping table
110 IOU
111 I/O device

1. An information processing device comprising:
a central processing unit; and
a host bus adapter in which input/output (I/O) devices conforming to a PCI Express standard are connected to a fabric, wherein
the host bus adapter is an input/output interface of the PCI Express standard, and communicates with an input/output unit (IOU) including at least one of the I/O devices by a fabric communication function, and
the host bus adapter includes a functional unit including a plurality of functions conforming to the PCI Express standard, and a mapping table in which the functions of the functional unit and external I/O devices connected to the fabric are mapped in association with each other.

2. The information processing device according to claim 1, wherein
the IOU including at least one of the I/O devices includes a virtual root port.

3. The information processing device according to claim 2, wherein
the virtual root port includes a routing table, and
the virtual root port transfers a packet received via the fabric communication function to a corresponding one of the I/O devices based on the routing table.

4. A method for controlling an information processing device including a central processing unit and a host bus adapter in which input/output (I/O) devices conforming to a PCI Express standard is connected to a fabric, wherein
the host bus adapter is an input/output interface of the PCI Express standard, and
the host bus adapter communicates with an input/output unit (IOU) including at least one of the I/O devices by a fabric communication function with reference to a mapping table in which a plurality of functions conforming to the PCI Express standard are associated with external I/O devices connected to the fabric.
